(19) United States
(12) Patent Application Publication
(10) Pub. No.: US 2007/0148070 A1
(43) Pub. Date: Jun. 28, 2007

(54) Production of moderate purity carbon dioxide streams

(76) Inventors: Shrikar Chakravarti, East Amherst, NY (US); Amitabh Gupta, Naperville, IL (US); Kenneth Burgers, East Amherst, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/315,065

(22) Filed: Dec. 23, 2005

(51) Int. Cl. B01D 53/14

(52) U.S. Cl. 423/220; 423/437.1

(57) ABSTRACT

A gaseous product stream having a predetermined carbon dioxide content of 10-95 mol. % is produced from a gaseous feed stream containing 3-20 mol. % carbon dioxide by converting a portion of the feed stream to a purified stream containing 95-99.9 mol. % (dry basis) carbon dioxide and adding the purified stream to the remaining portion of the feed stream. Alternately, a portion of the purified stream is stored and added subsequently in response to fluctuating demand for the product stream.

### FIELD OF THE INVENTION

The present invention relates to the production of gaseous streams containing carbon dioxide at purities considered moderate, by which is meant concentrations of 10 mol. % to 95 mol. %

### BACKGROUND OF THE INVENTION

Conventionally, liquid CO₂ having >99.99% purity (referred to herein and in commercial usage as “merchant” liquid CO₂) is produced from feed sources with high CO₂ purity (which term, as used herein, means a CO₂ content of ≧95%) using distillation technology. Examples of such sources include ammonia and hydrogen plant off-gases, fermentation sources and naturally-occurring gases in CO₂-rich wells. Typically, the liquid CO₂ is produced at a central plant and then transported to users that are frequently hundreds of miles away; this incurs high transportation costs.

The lack of high quality sources and their distance from customers provides motivation to recover CO₂ from low concentration sources, which are generally available close to or at customer sites. Predominant examples of such sources are flue gases, which typically contain 3-20 mol % CO₂ (the CO₂ depending upon the relative amounts of fuel and excess air used for combustion). Typically, flue gases can be found in abundant quantities at application sites throughout the year.

Typical amine based chemical absorption processes directly upgrade flue gas to-high purity (95-99.9 mol %, dry basis) CO₂ vapor. This stream can potentially be used as is or as a feed for the production of merchant liquid Co₂.

However, there are several applications which could potentially use CO₂ vapor streams of lower purities such as 10-95 mol %. Examples include pH control of water, and uses in production of aluminum and iron ore, in paper and pulp mills, and in wastewater treatment. Traditional practice for such applications that use moderate purity CO₂ is to have merchant liquid CO₂ (of >99.99% purity) shipped to the point of use from a liquid CO₂ production facility and vaporized prior to use. In effect, much higher purity is therefore used than necessary.

U.S. Pat. No. 5,482,539 describes the use of a membrane process for upgrading flue gas. The first step in any of these processes involves the compression of flue gas from atmospheric pressure to about 90 psia. Depending on the CO₂ content of the flue gas and the desired purity level in the product, multiple stages may be required. For a two-stage membrane process, the permeate (CO₂-rich) stream from the first stage is the feed to the second stage. Hence, an additional compressor will be required to increase the pressure of the first stage permeate stream from around 15 psia to 90 psia.

U.S. Pat. Nos. 4,578,089, 4,840,647 and 6,245,127 describe the use of adsorption technology for upgrading flue gas to moderate purity CO₂ vapor streams. These processes do not require much feed compression. However, they require the use of vacuum pumps for regeneration of the adsorption beds and recovery of the CO₂-rich product stream.

Conventional amine absorption processes directly upgrade flue gases to CO₂-rich vapor streams containing 95-99.9 mol. % CO₂ (dry basis). The present invention describes how the amine absorption process can be modified to cost-effectively recover moderate purity CO₂ from flue gases.

### BRIEF SUMMARY OF THE INVENTION

One aspect of the present invention is a method for producing a gaseous product stream containing carbon dioxide, comprising

(A) determining the desired carbon dioxide content of the gaseous product stream, provided that said carbon dioxide content is from 10 mol. % to 95 mol. % of said gaseous product stream;

(B) providing a processor which processes a gaseous input stream comprising 3 mol. % to 25 mol. % carbon dioxide and produces a gaseous purified stream comprising 95-99.9 mol. % (dry basis) carbon dioxide and having a pressure greater than the pressure of the gaseous input stream, by a process which includes absorption of carbon dioxide into an amine solution and desorption of the absorbed carbon dioxide from said amine solution;

(C) providing a gaseous feed stream comprising 3 mol. % to 25 mol. % carbon dioxide;

(D) determining the carbon dioxide content of the gaseous purified stream that is produced by processing in said processor a gaseous input stream having the carbon dioxide content of said gaseous feed stream;

(E) determining the amount of a gaseous additive stream, having the composition of said gaseous feed stream, that must be combined with a given amount of the gaseous purified stream having the carbon dioxide content determined in step (D) in order to form a gaseous product stream having the carbon dioxide content determined in step (A);

(F) determining the amount of said gaseous feed stream that must be fed to said processor as said gaseous input stream and processed in said processor in order to produce said given amount of said gaseous purified stream;

(G) dividing said gaseous feed stream provided in step (C) into a first stream and a second stream wherein the ratio of the flow rate of said first stream to the flow rate of said second stream is equal to the ratio of the amount determined in step (E) to the amount determined in step (F);

(H) feeding said second stream to said processor as the gaseous input stream thereto and processing it therein to produce said purified gaseous stream having a carbon dioxide content of 95-99.9 mol. % (dry basis);

(I) raising the pressure of said first stream to the pressure of said purified gaseous stream; and

(J) combining the purified gaseous stream produced in step (H) with the pressurized stream produced in step (I) thereby forming a gaseous product stream having the carbon dioxide content determined in step (A).

Another aspect of the present invention is a method for producing a gaseous product stream containing carbon dioxide and providing said product stream at rates that vary over a given length of time, comprising

(A) determining the desired flow rate and the desired carbon dioxide content of the gaseous product stream, provided that said carbon dioxide content is from 10 mol. % to 95 mol. % of said gaseous product stream;

(B) providing a processor which processes a gaseous input stream comprising 3 mol. % to 25 mol. % carbon dioxide and produces a gaseous purified stream comprising 95-99.9 mol. % (dry basis) carbon dioxide and having a pressure greater than the pressure of the gaseous input stream, by a process which includes absorption of carbon dioxide into an amine solution and desorption of the absorbed carbon dioxide from said amine solution;

(C) providing a vessel that is capable of receiving a gaseous purified stream from said processor, of holding carbon dioxide fed in said gaseous purified stream, and of controllably discharging a gaseous discharge stream having the composition of said gaseous purified stream;

(D) providing a gaseous feed stream comprising 3 mol. % to 25 mol. % carbon dioxide;

(E) dividing said gaseous feed stream provided in step (D) into a first stream and a second stream;

(F) feeding said second stream to said processor as the gaseous input stream thereto and processing it therein to produce said purified gaseous stream having a carbon dioxide content of 95-99.9 mol. % (dry basis);

(G) determining the amount of a gaseous stream having the carbon dioxide content of the gaseous purified stream, and the amount of a gaseous additive stream having the composition of said gaseous feed stream, that must be combined in order to form a gaseous product stream having the mass flow rate and the carbon dioxide content determined in step (A);

(H) raising the pressure of an amount of said first stream determined in step (G) to the pressure of said purified gaseous stream;

(I) combining a purified gaseous stream produced in step (F) with the pressurized stream produced in step (H) and optionally with an amount of gaseous discharge stream from said vessel, thereby forming a gaseous product stream having the mass flow rate and the carbon dioxide content determined in step (A), and

(J) intermittently or continuously feeding a gaseous purified stream from said processor into said vessel.

### BRIEF DESCRIPTION OF THE DRAWINGS

FIG. 1 is a flowsheet of one embodiment of the present invention.

FIG. 2 is a flowsheet of a processor, useful in the present invention, for producing high purity carbon dioxide.

FIG. 3 is a flowsheet of another embodiment of the present invention.

### DETAILED DESCRIPTION OF THE INVENTION

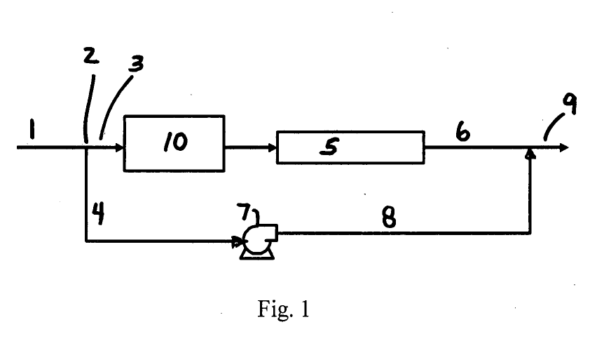

Referring first to FIG. 1, gaseous feed stream 1 comprises 3 mol % to 25 mol % carbon dioxide. Stream 1 can be an oxygen containing or reducing gas. It may typically contain other gaseous components such as nitrogen, argon, carbon monoxide, and oxygen, the amounts and the presence or absence being a function of the source of the gaseous feed stream. A preferred gaseous feed stream is flue gas, by which is meant a gaseous stream formed by complete or partial combustion of a hydrocarbon or carbohydrate fuel such as natural gas, coal, fuel oil, and the like, with air or any other gaseous feed that contains oxygen. The flue gas is conveyed from the point of combustion to constitute stream 1.

Typically, gaseous feed stream has a temperature of 90 to 120° F., and a pressure of near ambient to 20 psia. The temperature and pressure also depend on the source of this stream.

Gaseous feed stream 1 reaches point 2, at which it is split into streams 3 and 4. Point 2 is preferably a valve that can be controlled to vary, in accordance with considerations described herein, the amounts of flow that proceed as stream 3 and as stream 4.

Depending on the composition of the flue gas, stream 3 may optionally be passed through pretreatment, indicated at 10, for the removal of particulates and/or for the removal of SOx and/or NOx. Examples of suitable devices for removal of particulates include baghouse filters and electrostatic precipitators. Examples of suitable devices for removal of SOx and/or NOx include caustic scrubbers.

Stream 3 is fed into processor 5, which processes stream 3 and produces therefrom a gaseous purified stream 6 that comprises 95-99.9 mol. % (dry basis) carbon dioxide and that has a pressure higher than the pressure of stream 3. The pressure of stream 6 is typically 25 to 55 psia. (Pressures in excess of about 35 psia in stream 6 are achievable by practice of the processes disclosed in U.S. Pat. No. 6,497,852). Processor 5 includes a stage in which carbon dioxide is absorbed from stream 3 into an amine solution, and a stage in which carbon dioxide is desorbed from the amine solution.

Stream 4 is passed through a compressor 7 of any conventional design that raises the pressure of stream 4 to the pressure of gaseous purified stream 6. The resultant pressurized stream 8 is then combined with gaseous purified stream 6 to produce stream 9 having a carbon dioxide content of 10 mol. % to 95 mol. %.

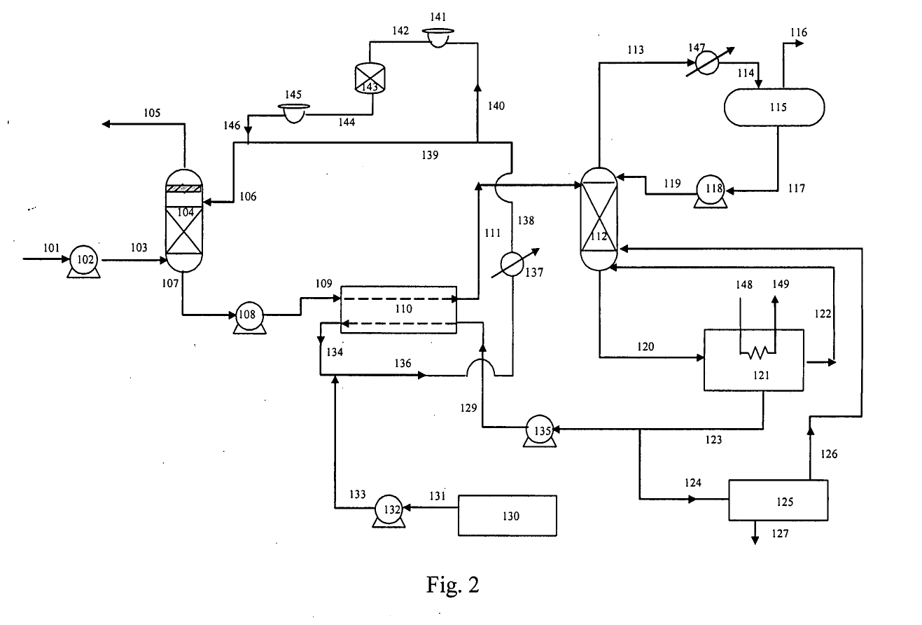

FIG. 2 depicts the flowsheet of a typical process that can be used as processor 5 that uses alkanolamine-based absorption and desorption for the recovery of a CO₂ vapor stream containing 95-99.9 mol. % (dry basis) CO₂ from a feed gas, such as flue gas, that typically contains 3-25 mol. % CO₂ and is at or slightly above atmospheric pressure. Variations in the flowsheet and equipment used are possible. The stages of optional but preferred removal of particulate, sulfur oxide, and nitrogen oxide impurities are omitted. The temperature and pressure values included in the following description are simply indicative of typical operating conditions.

The feed gas 101, which in the case of flue gas has preferably already been cooled to around 100° F. and pretreated for removal of particulates and impurities such as SOx and NOx, if required, is fed to the blower 102. The gas from the blower is then contacted countercurrently with lean alkanolamine stream 106 in absorber 104. The temperature in the absorber can typically vary from around 100-110° F. at the top to around 120-130° F. at the bottom. The absorber typically operates at slightly above ambient pressure. A mist eliminator at the top of the absorber traps any entrained amine in the absorber vent gas 105, which is essentially enriched nitrogen. CO₂ in the feed gas is absorbed by the alkanolamine and CO₂-rich alkanolamine stream 107 emerging from the bottom of the absorber 104 is fed to rich solvent pump 108. CO₂-rich solvent 109 is then heated in countercurrent heat exchanger 110 by hot regenerated or lean alkanolamine stream 129 to a temperature of 215-225° F. and subsequently fed to the top of stripper 112. Depending on the requirements for the pressure of the CO2-rich stream emerging from the top of the stripper, the pressure in the reboiler and at the bottom of the stripper 112 is maintained anywhere between 25-60 psia. The pressure drop across the stripper 112 typically does not exceed about 5 psi. The temperature at the top of the stripper 112 is typically between 215 and 225° F. while the bottom can be as high as 240-275° F.

Carbon dioxide, stripped from the alkanolamine solution through the use of steam, emerges as stream 113 from the top of the stripper and is fed to reflux condenser 147. Stream 114 from condenser 147 is then fed to reflux drum 115 where product CO₂ stream 116 is separated from condensate 117. The product CO₂ in stream 116 can be used as is, or can be passed through additional purification stages if the intended end use requires higher purification.

Reflux pump 118 pumps the condensate 117, which primarily comprises alkanolamine and water, to stripper 112. However, a pump 118 is unnecessary if the condensate can flow by gravity to the stripper. Solvent 120 from the bottom of stripper 112 is heated indirectly in reboiler 121, which typically operates at a temperature of around 240-275° F. Saturated steam 148 at a pressure of 30 psig or higher can provide the necessary heating. Heated solvent vapor 122 is recirculated to the stripper. The lean alkanolamine solution 123 from the reboiler is pumped back by the lean solvent pump 135 to heat exchanger 110. A small portion of stream 123 is withdrawn as stream 124 and fed to reclaimer 125, where the solution is vaporized. Depending on the composition of the absorbent solution, the reclaimer may operate at atmospheric or sub-atmospheric pressures. Addition of soda ash or caustic soda to the reclaimer 125 facilitates precipitation of degradation byproducts and heat stable amine salts. Stream 127 depicts the disposal of the degradation byproducts and heat stable amine salts. The vaporized amine solution 126 can be reintroduced into the stripper 112 as shown in FIG. 1. It can also be cooled and directly mixed with the lean alkanolamine stream 106 entering the top of the absorber.

Also, instead of the reclaimer 125 shown in FIG. 1, other purification methods such as ion-exchange or electrodialysis could also be employed. Makeup amine 133 is pumped from storage tank 130 and combined with the lean alkanolamine stream 134, which exits the heat exchanger 110 at a temperature of around 140-170° F., to form stream 136, which is further cooled in an amine cooler 137 to around 100° F. From the cooled lean alkanolamine stream 138, a small portion is withdrawn and purified (for removal of impurities, solids, degradation byproducts and heat stable amine salts) through the use of mechanical filters 141 and 145 as well as a carbon bed filter 143. The purified lean alkanolamine stream 146 is added to stream 139 to form stream 106 which is fed to the top of the absorption column.

Alkanolamines useful in the invention include single compounds, and mixtures of compounds, that conform to the formula NR¹R²R³ wherein R¹ is hydroxyethyl, hydroxyisopropyl, or hydroxy-n-propyl, R² is hydrogen, hydroxyethyl, hydroxyisopropyl, or hydroxy-n-propyl, and R³is hydrogen, methyl, ethyl, hydroxyethyl, hydroxyisopropyl, or hydroxy-n-propyl; or wherein R¹ is 2-(2′-hydroxyethoxy)-ethyl, i.e. HO—CH₂CH₂OCH₂CH₂- and both R² and R³ are hydrogen. Preferred examples of alkanolamines which may be employed in absorber fluid 6 in the practice of this invention are monoethanolamine (also referred to as “MEA”), diethanolamine, diisopropanolamine, methyldiethanolamine (also referred to as “MDEA”) and triethanolamine.

The concentrations of the alkanolamine(s) in absorbent 6 are typically within the range of from 5 to 80 weight percent, and preferably from 10 to 50 weight percent. For example, a preferred concentration of monoethanolamine for use in the absorbent fluid in the practice of this invention is from 5 to 25 weight percent, more preferably from 10 to 15 weight percent.

Referring again to FIG. 1, the attainment of a product stream 9 of any desired carbon dioxide content of 10 mol. % to 95 mol. % can begin with deciding what the desired carbon dioxide content is. Then, one determines the amounts of streams 6 and 8 (relative to each other) that should be combined with each other (knowing the carbon dioxide contents of streams 6 and 8) to produce a stream 9 having that desired carbon dioxide content. From the amount of stream 6 that is found to be needed, one then determines the amount of stream 3 that should be fed to processor 5, which is based on the yield of processor 5. Then, since one now knows the desired amounts (relative to each other) of streams 3 and 4, one needs only to set the valve 2 (or other equivalent technique) to provide the appropriate split of stream 1 that will provide the amounts of streams 3 and 4 with respect to each other that are needed to provide the desired streams 6 and 8.

One advantage of this method is that the maximum capacity of the processor, expressed as the maximum amount of carbon dioxide-containing gaseous purified stream that it can produce in a given period of time, is less than what would be necessary to convert in the processor all of the gaseous feed stream into the gaseous purified stream. Expressed another way, the ratio of the amount of carbon dioxide in the maximum amount of gaseous purified stream 6 that the processor needs to be able to produce to the amount of carbon dioxide in the gaseous product stream 9 is less than 0.95 and is preferably less than 0.9.

Another advantage of this method of the present invention is that at no point is any carbon dioxide liquefied or solidified. This aspect is an advantage because it avoids the expenditure of energy that is involved in liquefaction and solidification.

This method of the present invention is useful whenever the costs saved by constructing and operating a processor that treats less than all of the feed gas, rather than one that treats all of the feed gas, exceed the total cost (capital, operating, etc.) of compressor 7.

Another aspect of this invention is an adaptation to periodic use pattern wherein the gaseous product stream of moderate purity CO₂ only needs to be provided intermittently. The simplest example is one where the customer has several cycles in a day (or other period of time) with an on-time where the product CO₂ stream is consumed at a fixed rate, e.g. 50 tons/day, and an off-time where the product CO₂ stream is not consumed at all, i.e. 0 tons/day. To date, CO₂ recovery processes are typically built to operate in continuous fashion at a fixed production rate. Thus one approach to meet the periodic use pattern of the customer is to size the amine plant to meet the peak consumption rate of the customer and to vent the CO₂-rich product stream during off-times, i.e. when CO₂ is not required. The method described above for producing gaseous product stream 9 is performed only during on-times. However, this approach results in capital and operating costs that can be lowered still further with the alternative embodiment described hereinbelow. This embodiment uses intermediate storage to help cope with the periodic use pattern of the customer while significantly reducing the cost penalty.

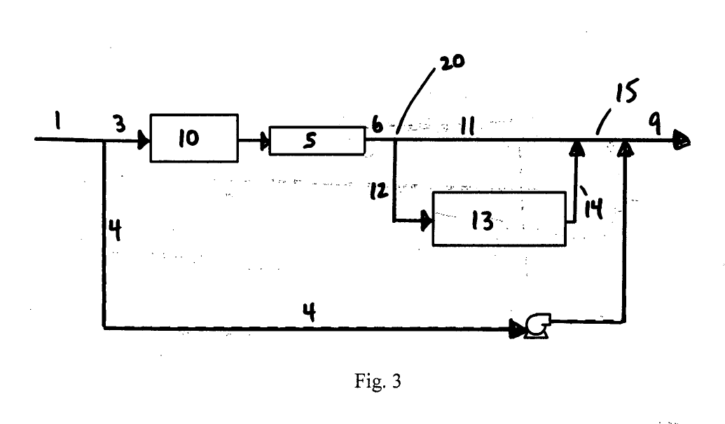

Referring to FIG. 3, the reference numerals that are common to FIGS. 3 and 1 indicate the same streams and components that they indicate in FIG. 1. In FIG. 3, gaseous purified stream 6 is conveyed to point 20, which can be a controllable valve or equivalent unit. At point 20, stream 6 can be split into streams 11 and 12. Stream 12 feeds into storage vessel 13. Stream 14 emerges from vessel 13 and feeds into stream 11 to form stream 15. Stream 8 feeds into stream 15 to form stream 9.

FIG. 3 represents an embodiment in which the gaseous purified stream from processor 5 can be stored in times when there is no need, or when there is only a reduced need compared to the average need over time, to produce a gaseous product stream 9. During those off-times, all or a portion of the purified gaseous stream is diverted into vessel 13 where the carbon dioxide can be stored. Any excess purified gaseous stream can be vented to the atmosphere or diverted to other uses that employ a gas stream having that composition. During the times when the gaseous product stream is desired, the needs for that stream can be satisfied by combining three streams: the gaseous purified stream 11 from processor 5 which bypasses vessel 13, carbon dioxide released from vessel 13, and feed gas from stream 8. The amounts of each stream to combine are determined starting from the carbon dioxide content and the volume desired to pass in stream 9, and from the carbon dioxide content and flow rate of streams 1 and 4, and from the carbon dioxide yield and flow rate into and out of processor 5. From these, and from considerations of how much stored carbon dioxide is present in vessel 13 and how rapidly one wishes to deplete the amount of carbon dioxide stored therein, one determines the amounts of streams 3 and 4 relative to each other to establish, and the amounts relative to each other of streams 12 and 11 to make up stream 15, and the amounts relative to each other of streams 15 and 8.

This embodiment provides significant cost savings by a reduction in the size of the processor (compared to passing all of the feed stream through processor 5 or for that matter the blending process where the amine plant has been sized to meet the peak consumption rate of the customer) as well as more efficient utilization of the processor 5.

The vessel 13 is a device capable of receiving and controllably releasing (as stream 14) the carbon dioxide-containing gaseous stream, and of storing carbon dioxide. One example of a useful vessel 13 is a gas bladder or equivalent device, which stores in the gaseous state the gaseous stream that is fed to it. Use of a gas bladder is recommended as long as the volume requirement is less than about 300,000 standard cubic feet. For off-times of higher duration, the size requirement for the gas bladder tends to get very large and impractical. Consequently, some of the carbon dioxide-containing stream from the processor 5 would have to be vented.

Another example of a useful vessel 13 is a tank that includes a condensation system which liquefies at least a portion of at least the carbon dioxide component of the gas stream 12 fed to vessel 13, and which revaporizes the liquefied carbon dioxide when the operator decides to provide carbon dioxide in stream 14. Alternately, the system can convert at least a portion of at least the carbon dioxide component of the stream 12 into solid, which is revaporized when needed, but this alternative may be less suitable as it imposes a higher energy cost. While a condensation system that liquefies and/or solidifies carbon dioxide from stream 12 may entail more capital expense as compared to a system that stores the stream entirely in its gaseous state, the overall process could be more economical due to 100% utilization of the processor 5 (because none of the carbon dioxide vapor from the processor 5 would need to be vented).

For processors that use semipermeable membranes or adsorption technology instead of amine-based absorption technology, the gaseous purified stream that is recovered generally comprises carbon dioxide that is at the desired purity level. In such cases, when the desired carbon dioxide level is relatively low, e.g. 10-50%, use of schemes that include intermediate storage in vessel 13 will be impractical. The volume requirement for a gas bladder would be too large since a significant fraction of the volume would be used to store the non-carbon dioxide component of the mixture, e.g. nitrogen. Condensation, even if possible, would also be very expensive, for the same reason. However, since the amine absorption and desorption stages in processor 5 always yield a pirified stream containing 95-99.9 mol. % (dry basis) CO₂, the embodiments including vessel 13 can be practical and economical.

This invention is superior to other techniques for providing gaseous streams containing moderate levels of carbon dioxide for many reasons, including the following.

The use of merchant liquid CO₂ for moderate purity vapor applications results in additional costs including the cost of excessive purification, the original cost of liquefaction, the cost of delivery from the central plant and the cost of vaporization. By contrast, the method of the present invention directly provides CO₂ vapor of the desired purity, thus eliminating the costs of excessive purification, liquefaction and vaporization. Furthermore, the method can be practiced at the application site, thus eliminating all transportation costs.

Upgrading flue gas using membranes generally requires a high degree of compression and multiple separation steps, which significantly increase capital and operating costs. By contrast, the method of the present invention enables the desired level of flue gas upgrade with minimal compression and in a single separation step.

Recovering moderate purity CO₂ from flue gas using pressure swing adsorption (PSA) processes typically requires deep levels of vacuum in the regeneration step. By contrast, the enhanced chemical absorption process achieves the necessary separation without any vacuum requirements.

In another embodiment of the invention, the feed to processor 5 and the feed to compressor 7 could be from distinct sources. The other considerations described above will then be applied to the practice of the invention.

What is claimed is:

1. A method for producing a gaseous product stream containing carbon dioxide, comprising
(A) determining the desired carbon dioxide content of the gaseous product stream, provided that said carbon dioxide content is from 10 mol. % to 95 mol. % of said gaseous product stream;
(B) providing a processor which processes a gaseous input stream comprising 3 mol. % to 25 mol. % carbon dioxide and produces a gaseous purified stream comprising 95-99.9 mol. % (dry basis) carbon dioxide and having a pressure greater than the pressure of the gaseous input stream, by a process which includes absorption of carbon dioxide into an amine solution and desorption of the absorbed carbon dioxide from said amine solution;
(C) providing a gaseous feed stream comprising 3 mol. % to 25 mol. % carbon dioxide;
(D) determining the carbon dioxide content of the gaseous purified stream that is produced by processing in said processor a gaseous input stream having the carbon dioxide content of said gaseous feed stream;
(E) determining the amount of a gaseous additive stream, having the composition of said gaseous feed stream, that must be combined with a given amount of the gaseous purified stream having the carbon dioxide content determined in step (D) in order to form a gaseous product stream having the carbon dioxide content determined in step (A);
(F) determining the amount of said gaseous feed stream that must be fed to said processor as said gaseous input stream and processed in said processor in order to produce said given amount of said gaseous purified stream;
(G) dividing said gaseous feed stream provided in step (C) into a first stream and a second stream wherein the ratio of the flow rate of said first stream to the flow rate of said second stream is equal to the ratio of the amount determined in step (E) to the amount determined in step (F);
(H) feeding said second stream to said processor as the gaseous input stream thereto and processing it therein to produce said purified gaseous stream having a carbon dioxide content of 95-99.9 mol. % (dry basis);
(I) raising the pressure of said first stream to the pressure of said purified gaseous stream; and
(J) combining the purified gaseous stream produced in step (H) with the pressurized stream produced in step (I) thereby forming a gaseous product stream having the carbon dioxide content determined in step (A).

2. A method according to claim 1 wherein said gaseous feed stream comprises flue gas.

3. A method for producing a gaseous product stream containing carbon dioxide and providing said product stream at rates that vary over a given length of time, comprising
(A) determining the desired mass flow rate and the desired carbon dioxide content of the gaseous product stream, provided that said carbon dioxide content is from 10 mol. % to 95 mol. % of said gaseous product stream;
(B) providing a processor which processes a gaseous input stream comprising 3 mol. % to 25 mol. % carbon dioxide and produces a gaseous purified stream comprising 95-99.9 mol. % (dry basis) carbon dioxide and having a pressure greater than the pressure of the gaseous input stream, by a process which includes absorption of carbon dioxide into an amine solution and desorption of the absorbed carbon dioxide from said amine solution;
(C) providing a vessel that is capable of receiving a gaseous purified stream from said processor, of holding carbon dioxide fed in said gaseous purified stream, and of controllably discharging a gaseous discharge stream having the composition of said gaseous purified stream;
(D) providing a gaseous feed stream comprising 3 mol. % to 25 mol. % carbon dioxide;
(E) dividing said gaseous feed stream provided in step (D) into a first stream and a second stream;
(F) feeding said second stream to said processor as the gaseous input stream thereto and processing it therein to produce said purified gaseous stream having a carbon dioxide content of 95-99.9 mol. % (dry basis);
(G) determining the amount of a gaseous stream having the carbon dioxide content of the gaseous purified stream, and the amount of a gaseous additive stream having the composition of said gaseous feed stream, that must be combined in order to form a gaseous product stream having the mass flow rate and the carbon dioxide content determined in step (A);
(H) raising the pressure of an amount of said first stream determined in step (G) to the pressure of said purified gaseous stream;
(I) combining a purified gaseous stream produced in step (F) with the pressurized stream produced in step (H) and optionally with an amount of gaseous discharge stream from said vessel, thereby forming a gaseous product stream having the mass flow rate and the carbon dioxide content determined in step (A); and
(J) intermittently or continuously feeding a gaseous purified stream from said processor into said vessel.

4. A method according to claim 3 wherein said vessel is capable of holding at least a portion of said carbon dioxide as a gas.

5. A method according to claim 3 wherein said vessel is capable of liquefying at least a portion of said carbon dioxide, of holding liquefied carbon dioxide, and of revaporizing said liquefied carbon dioxide.

6. A method according to claim 3 wherein said vessel is capable of solidifying at least a portion of said carbon dioxide, of holding solidified carbon dioxide, and of revaporizing said solidified carbon dioxide.

7. A method according to claim 3 wherein said gaseous feed stream comprises flue gas.

8. A method according to claim 7 wherein said vessel is capable of holding at least a portion of said carbon dioxide as a gas.

9. A method according to claim 7 wherein said vessel is capable of liquefying at least a portion of said carbon dioxide, of holding liquefied carbon dioxide, and of revaporizing said liquefied carbon dioxide.

10. A method according to claim 7 wherein said vessel is capable of solidifying at least a portion of said carbon dioxide, of holding solidified carbon dioxide, and of revaporizing said solidified carbon dioxide.
